(19) United States
(12) Patent Application Publication
(10) Pub. No.: US 2012/0073142 A1
(43) Pub. Date: Mar. 29, 2012

(54) Cutting Apparatus

(76) Inventor: Min-Zheng Zeng, Nantou City (TW)

(21) Appl. No.: 12/890,601

(22) Filed: Sep. 24, 2010

(51) Int. Cl. B26B 5/00; B26B 1/08

(52) U.S. Cl. 30/162; 30/338

(57) ABSTRACT

A cutting apparatus includes a sheath with an entrance, a slot, extrusion and withdrawal recesses, a positioning aperture and a discarding aperture. A handle is pivotally connected to the sheath. A first button is inserted through and movable along the slot between a position where bosses thereof are in the extrusion recesses and another position where the bosses are in the withdrawal recesses. A second button is inserted through the discarding aperture. A carrier is movably located in the sheath and connected to the first button. A jaw is connected to the carrier. Teeth of the jaw are moved out of cutouts of a blade when the jaw is pushed by the second button as the second button is pressed. A cassette can be inserted in the sheath so that a positioning block thereof can be inserted in the positioning aperture.

### BACKGROUND OF INVENTION

1. Field of Invention

The present invention relates to a cutting apparatus and, more particularly, to a simple and safe cutting apparatus with a blade-storing unit.

2. Related Prior Art

Clerks may use so-called art designer's knifes for cutting pieces of paper. Carpenters may use heavy-duty art designer's knifes for cutting thin sheets of wood or acrylic sheets.

A conventional art designer's knife includes a blade that is replaceable with a new one, after it is worn away. The replacement is conducted by a user with bare hands. The used blade is however sharp enough to cut the user. There are risks for the user of getting hurt during the replacement.

There has been devised an art designer's knife including a blade-storing unit to reduce the need for human contact with the blades during the replacement. The blade-storing unit however includes many elements and is therefore complicated. The cost is high. Moreover, the blade-storing unit might fail should one of the elements fail.

The present invention is therefore intended to obviate or at least alleviate the problems encountered in prior art.

### SUMMARY OF INVENTION

It is the primary objective of the present invention to provide a simple, inexpensive and reliable cutting apparatus with a blade-storing unit.

To achieve the foregoing objective, the cutting apparatus includes a sheath, a handle, first and second buttons, a blade carrier, a jaw and a cassette. The sheath includes a chamber defined therein, an exit in communication with the chamber, an entrance in communication with the chamber, a slot in communication with the chamber, extrusion and withdrawal recesses defined in each of two walls of the slot, a positioning aperture defined therein, and a discarding aperture defined therein. The handle is pivotally connected to the sheath between an opening position for opening the entrance and a closing position for closing the entrance. The first button includes two bosses formed thereon. The first button is inserted through and movable along the slot between an extrusion position where the bosses are located in the extrusion recesses and a withdrawal position where the bosses are located in the withdrawal recesses. The second button is inserted through the discarding aperture. The blade carrier is movably located in the chamber and connected to the first button. The jaw includes at least one tooth for insertion in at least one cutout defined in a blade. The jaw is connected to the blade carrier. The tooth of the jaw is moved out of the cutout of the blade when the jaw is pushed by the second button as the second button is pressed. The cassette includes a positioning block formed thereon. The positioning block can be inserted in the positioning aperture when the cassette is inserted in the chamber via the entrance.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded view of a cutting apparatus according to the preferred embodiment of the present invention;

FIG. 2 is a perspective view of the cutting apparatus shown in FIG. 1;

FIG. 3 is a side view of the cutting apparatus shown in FIG. 1;

FIG. 4 is a cross-sectional view of a blade-storing unit of the cutting apparatus shown in FIG. 1;

FIG. 5 is a cross-sectional, partial view of the cutting apparatus shown in FIG. 1;

FIG. 6 is a side, partial view of the cutting apparatus shown in FIG. 1;

FIG. 7 is a side, partial view of the cutting apparatus in another position than shown in FIG. 6;

FIG. 8 is a cross-sectional, partial view of the cutting apparatus in another position than shown in FIG. 5;

FIG. 9 is a side, partial view of the cutting apparatus in another position than shown in FIG. 7;

FIG. 10 is a cross-sectional, partial view of the cutting apparatus in another position than shown in FIG. 8; and

FIG. 11 is a cross-sectional view of the cutting apparatus shown in FIG. 10.

### DETAILED DESCRIPTION OF PREFERRED EMBODIMENT

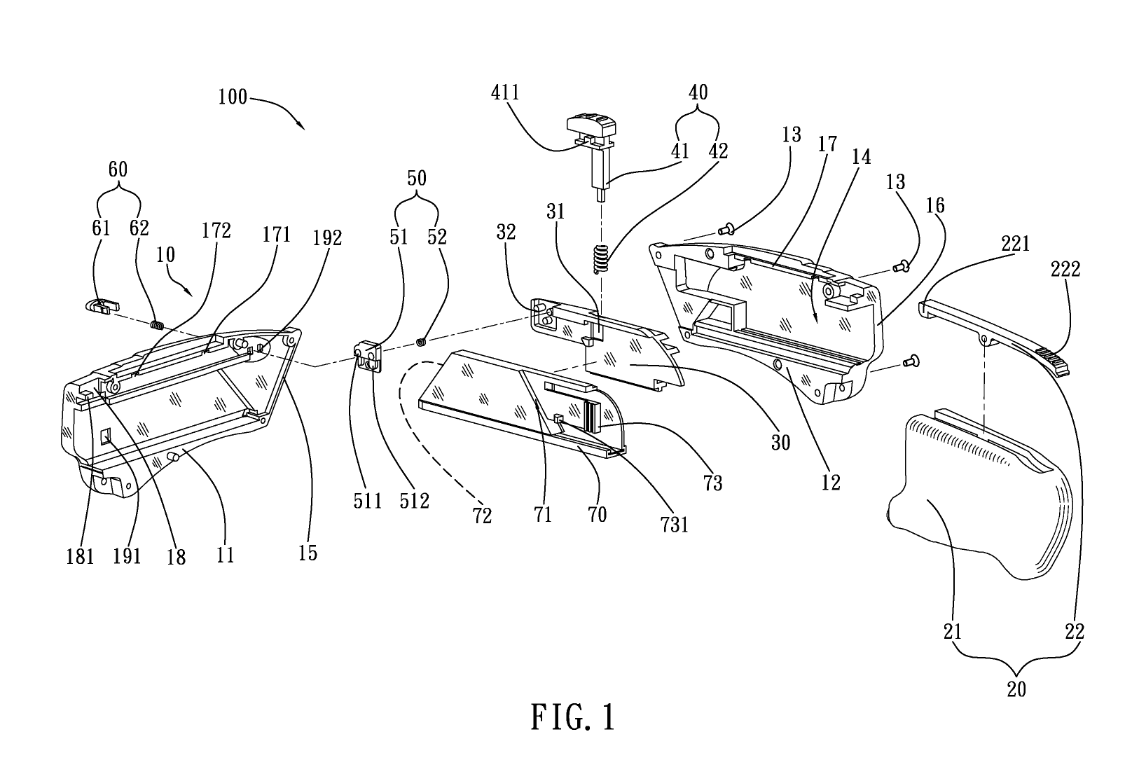

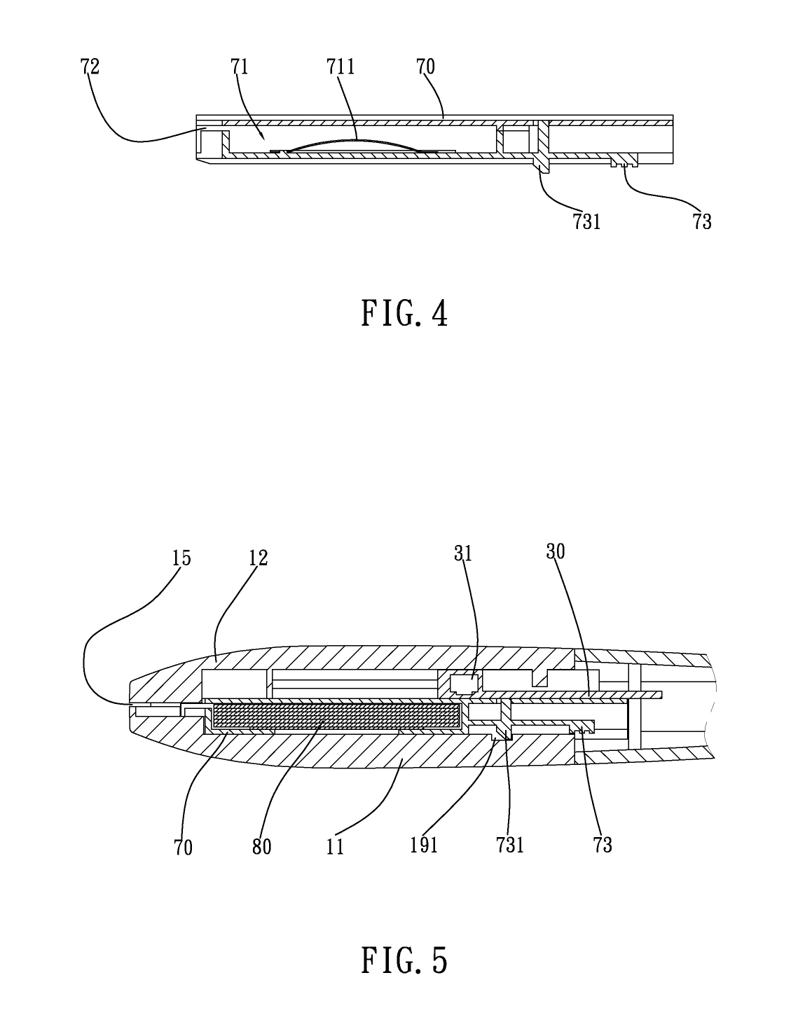

Referring to FIGS. 1 to 5, a cutting apparatus 100 includes a sheath 10, a handle unit 20, a blade carrier 30, a button unit 40, a blade-engaging unit 50, a blade-discarding unit 60 and a blade-storing unit according to the preferred embodiment of the present invention.

The sheath 10 includes a first shell 11 joined with a second shell 12 by screws 13 for example. The sheath 10 includes a chamber 14 defined therein for containing the blade carrier 30 and the blade-engaging unit 50. The sheath 10 includes an exit 15 defined in a front end of the sheath 10, an entrance 16 defined in a rear end of the sheath 10, and a slot 17 defined in an upper portion of the sheath 10. The exit 15, the entrance 16 and the slot 17 are in communication with the chamber 14. The slot 17 is defined between a portion of the first shell 11 and a corresponding portion of the second shell 12. An extrusion recess 171 and a withdrawal recess 172 are defined in the portion of each of the shells 11 and 12. Moreover, the sheath 10 includes a cavity 18 defined in the upper portion near the rear end and a block 181 formed on the upper portion near the cavity 18. The first shell 11 includes a positioning aperture 191 defined therein near the rear end and two withdrawal apertures 192 defined therein near the front end.

The handle unit 20 includes a handle 21 and a hook 22. The handle 21 is pivotally connected to the sheath 10 by a screw for example. The hook 22 is pivotally connected to the handle 21 like a seesaw. The hook 22 includes a barb 221 formed on a lower face near a front end, ridges 222 formed on an upper face near a rear end, and a lug formed on the lower face between the front and rear ends. The hook 22 is pivotally connected to the handle 21 by inserting a pin through the lug of the hook 22 and in two opposite portions of the handle 21. The ridges 222 are used for contact with a user's thumb. The user can press the ridges 222 to pivot the hook 22 between a locking position and a releasing position. In the locking position, the barb 221 of the hook 22 is engaged with the block 181 of the sheath 10, thus retaining the handle 21 in line with the sheath 10. In the releasing position the barb 221 is disengaged from the block 181, thus allowing the handle 21 to be pivoted relative to the sheath 10.

The blade carrier 30 is movably located in the sheath 10. The blade carrier 30 includes a roof formed on a wall. An aperture 31 is defined in the roof of the blade carrier 30. Rods 32 extend horizontally from the wall of the blade carrier 30.

The blade-engaging unit 50 includes a jaw 51 and a spring 52. The jaw 51 includes apertures 511 defined therein and teeth 512 formed thereon. The jaw 51 is connected to the blade carrier 30 by inserting the rods 32 of the blade carrier 30 in the apertures 511 of the jaw 51. The spring 52 is compressed between the jaw 51 and the blade carrier 30.

The button unit 40 includes a button 41 and a spring 42. The button 41 includes a head formed on a body. The head is formed with ridges for contact with the thumb. Two opposite bosses 411 are formed on the body of the button 41. The bosses 411 are shaped corresponding to the extrusion recesses 171 and the withdrawal recesses 172. The body of the button 41 is movably located in the aperture 31 of the blade carrier 30 while the head of the button 41 is located outside the sheath 10. Furthermore, the body of the button 41 is movably inserted through the slot 17 of the sheath 10. The spring 42 is compressed between a portion of the blade carrier 30 and the head of the button 41.

The blade-discarding unit 60 includes a button 61 and a spring 62. The button 61 includes two hooks inserted through the withdrawal apertures 192 of the sheath 10. The hooks are engaged with two portions of the first shell 11 so that the button 61 is connected to the first shell 11. The spring 62 is compressed the button 61 and the first shell 11.

The blade-storing unit includes a cassette 70 and a leaf spring 711. The cassette 70 is movably inserted in the chamber 14 of the sheath 10. The cassette 70 includes a cavity 71 for containing blades 80 and an exit 72 through which the blades can be fed from the cavity 71 one after another. The cavity 71 is defined between first and second walls of the cassette 70. The exit 72 is located near the first wall of the cassette 70. The cassette 70 includes an elastic strip 73 formed thereon by making a U-shaped slit therein. The elastic strip 73 includes a positioning block 731 formed thereon. The positioning block 731 is located in the positioning aperture 191 of the first shell 11 when the cassette 70 is inserted in the chamber 14. The positioning block 731 preferably includes a slope for facilitating the insertion of the positioning block 731 into the positioning aperture 191. A portion of the elastic strip 73 is located outside the chamber 14 of the sheath 10 when the cassette 70 is inserted in the chamber 14. The leaf spring 711 is attached to the second wall of the cassette 70.

In use, the blades 80 are located side by side in the cavity 71 of the cassette 70. The blades 80 are biased pushed against the first wall of the cassette 70 near which the exit 72 is located. That is, the first blade 80 is aligned with the exit 72. Each of the blades 80 includes cutouts 81 defined in an upper edge.

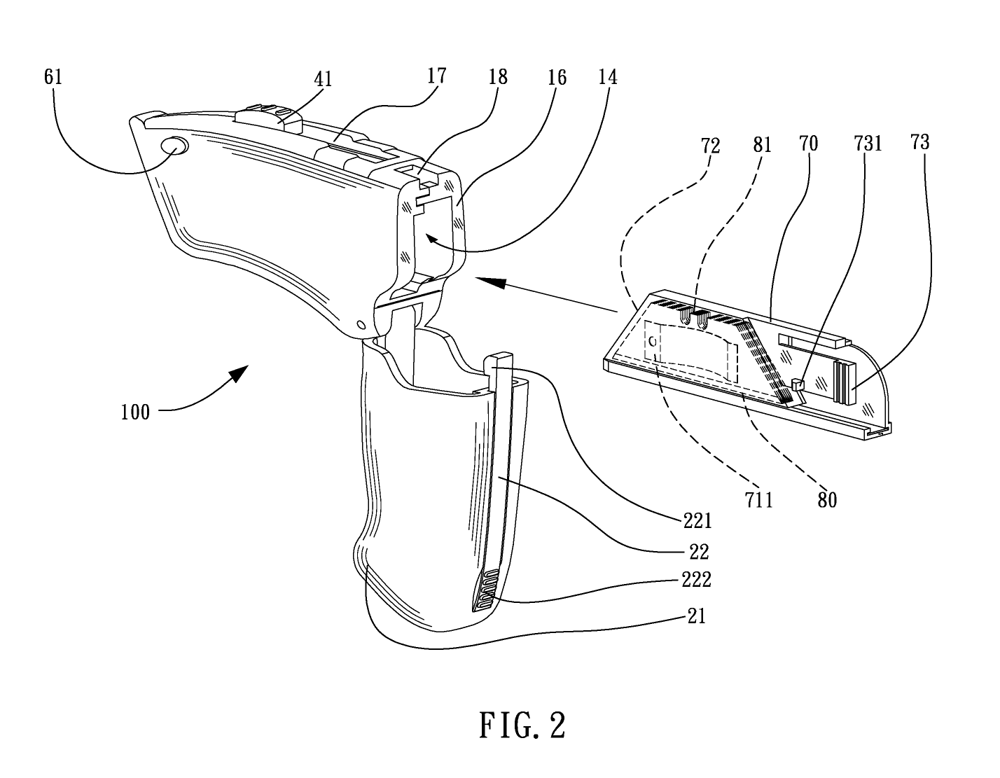

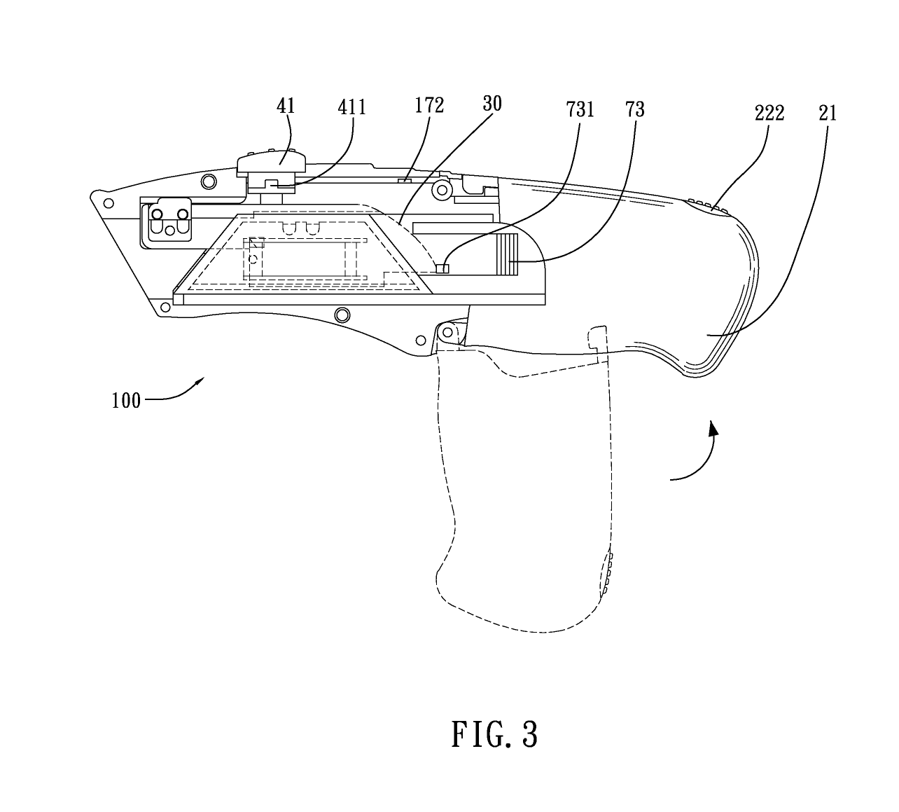

The barb 221 is moved out of the cavity 18, i.e., disengaged from the block 181 by pressing the ridges 222 of the hook 22. That is, the hook 22 is in the releasing position. The handle unit 20 is pivoted relative to the sheath 10 in a direction to open the entrance 16 of the sheath 10 as shown in FIG. 2. The blade-storing unit is inserted in the chamber 14 of the sheath 10. The positioning block 731 of the blade-storing unit is inserted in the positioning aperture 191 of the sheath 10 to retain the blade-storing unit within the sheath 10. Then, the handle unit 20 is pivoted in an opposite direction to close the entrance 16 of the sheath 10 again as shown in FIG. 3. The barb 221 is inserted in the cavity 18 again, i.e., engaged with the block 181 again. That is, the hook 22 is in the releasing position. Hence, the entrance 16 of the sheath 10 is retained closed.

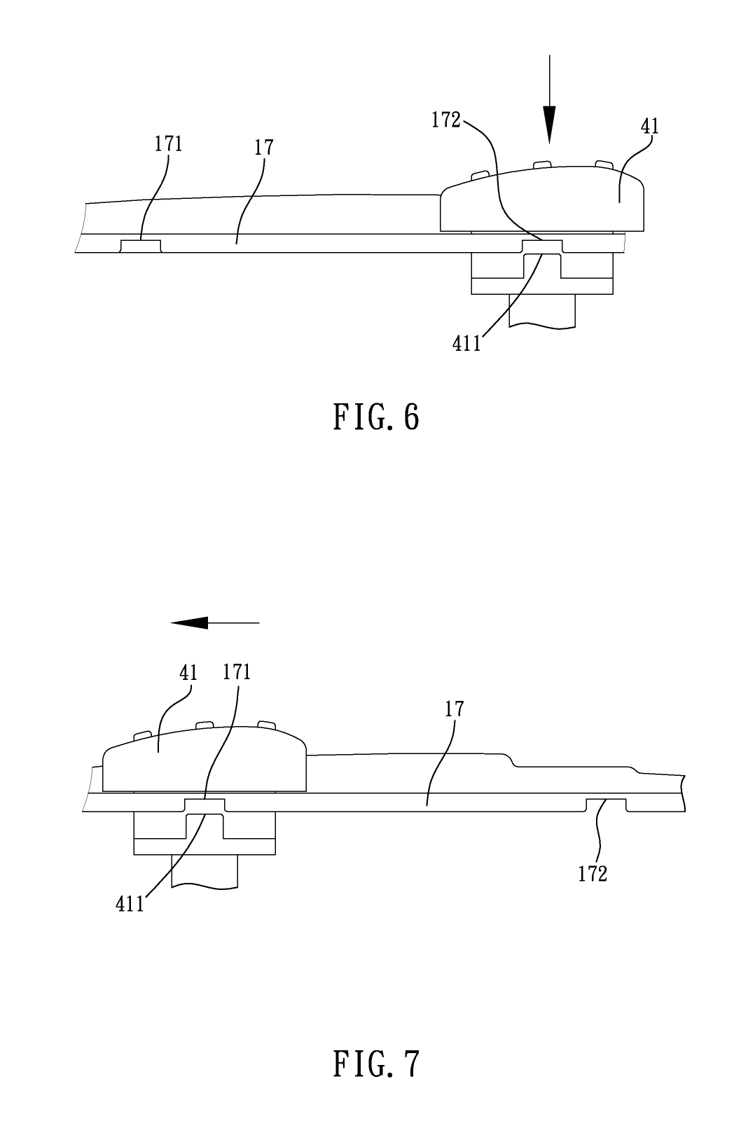

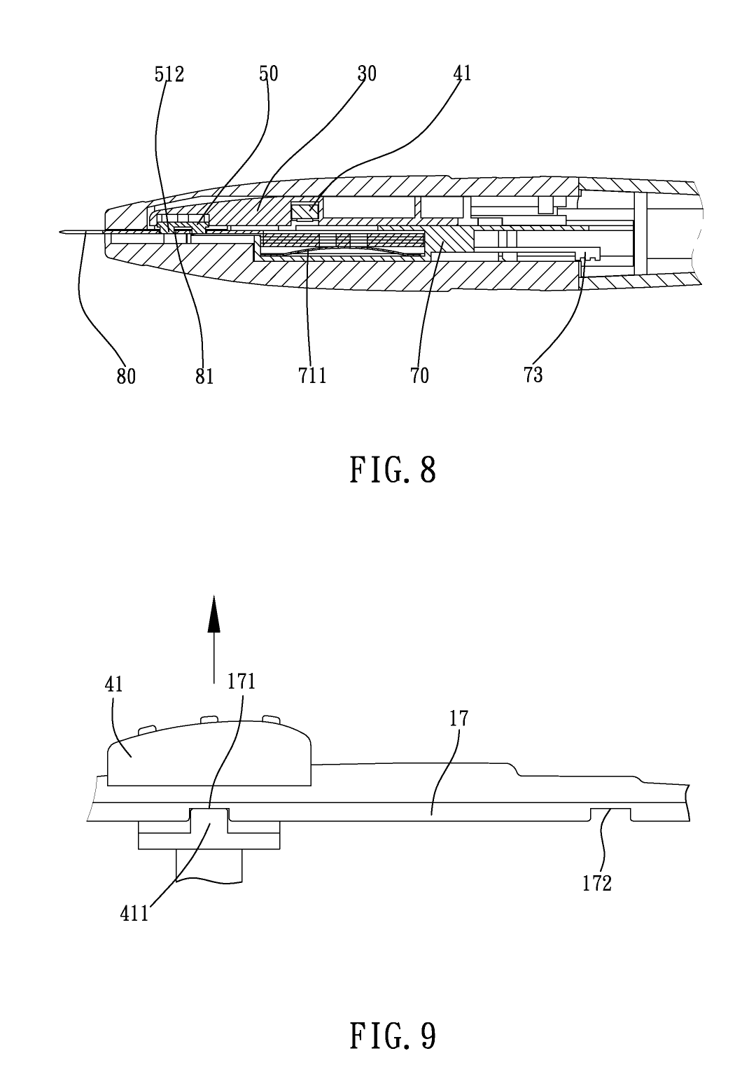

Now, the jaw 51 is pushed by the spring 52, which is loaded, so that the teeth 512 are inserted in the cutouts 81 of the first blade 80, which is aligned with the exit 72. The button 41 is pressed so that the bosses 411 are moved out of the withdrawal recesses 172 of the sheath 10 as shown in FIG. 6 and that the spring 42 is loaded. Then, the button 41 is moved to an extension position as shown in FIG. 7 from the withdrawal position as shown in FIG. 6. The blade carrier 30 and the blade-engaging unit 50 are synchronously moved together with the button 41. Thus, the first blade 80 is moved out of the cassette 70 through the exit 72 by the jaw 51 as shown in FIG. 8. Then, the button 41 is released so that the bosses 411 are inserted into the extrusion recesses 171 of the sheath 10 by the spring 42, which is loaded, as shown in FIG. 9. The button 41 is retained in the extrusion position. Now, the cutting apparatus 100 can be used to cut.

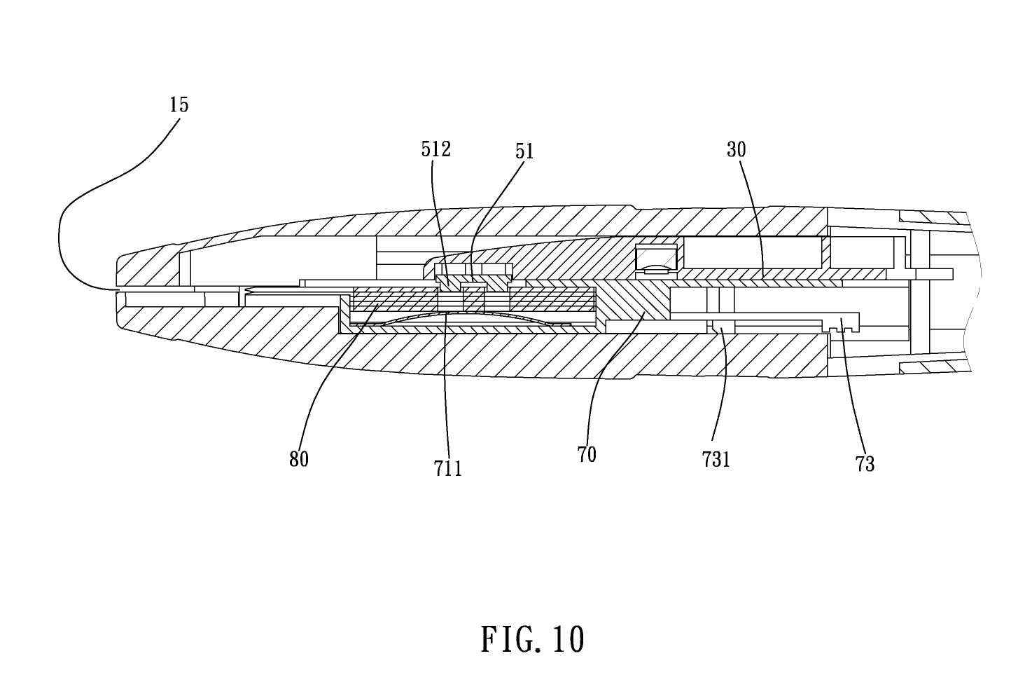

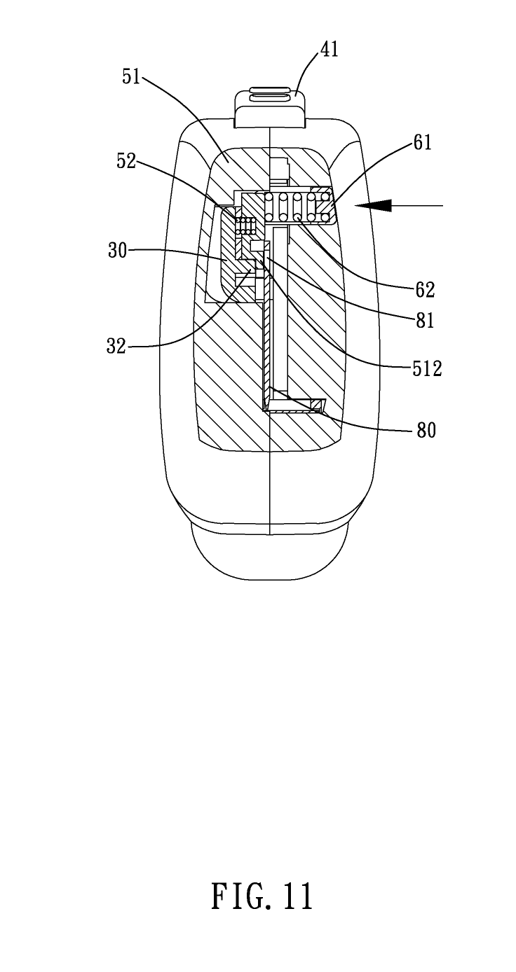

To withdraw the first blade 80, the foregoing process is reversed. That is, the button 41 is pressed to move the bosses 411 out of the extrusion recesses 171. Then, the button 41 is returned to the withdrawal position from the extrusion position. Thus, the bosses 411 are located in the withdrawal recesses 172 again. Synchronously, the blade carrier 30, the blade-engaging unit 50 and the blades 80 are withdrawn as shown in FIG. 10. To replace the first blade 80 with the second blade 80, the button 61 is pressed when the button 41 is in the extrusion position. Thus, the spring 62 is loaded by the button 61 for returning the jaw 51 when the button 61 is released. Synchronously, the jaw 51 is pushed by the button 61. Hence, the teeth 512 are moved out of the cutouts 81 of the first blade 80 as shown in FIG. 11 to allow the removal of the first blade 80 from the jaw 51.

The foregoing process can be repeated until all of the blades 80 are used, worn away and removed from the blade-storing unit. To fill more blades 80 in the blade-storing unit, the blade-storing unit has to be removed from the sheath 10. To this end, the ridges 222 of the hook 22 are pushed to disengage the barb 221 from the block 181. The handle 21 is pivoted from the sheath 10. The entrance 16 of the sheath 10 is opened and the elastic strip 73 is exposed to the exterior of the sheath 10. The elastic strip 73 is pressed to move the block 731 out of the positioning aperture 191. Finally, the blade-storing unit 70 is moved out of the sheath 10.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A cutting apparatus including:
a sheath including a chamber defined therein, an exit in communication with the chamber, an entrance in communication with the chamber, a slot in communication with the chamber, extrusion and withdrawal recesses defined in each of two walls of the slot, a positioning aperture defined therein, and a discarding aperture defined therein;
a handle pivotally connected to the sheath between an opening position for opening the entrance;
a first button including two bosses formed thereon, wherein the first button is inserted through and movable along the slot between an extrusion position where the bosses are located in the extrusion recesses and a withdrawal position where the bosses are located in the withdrawal recesses;
a second button inserted through the discarding aperture;
a blade carrier located in the chamber and movable together with the first button;
a jaw including at least one tooth for insertion in at least one cutout defined in a blade, wherein the jaw is connected to the blade carrier, wherein the tooth of the jaw is moved out of the cutout of the blade when the jaw is pushed by the second button as the second button is pressed; and
a cassette including a positioning block formed thereon, wherein the positioning block can be inserted in the positioning aperture when the cassette is inserted in the chamber via the entrance.

2. The cutting apparatus according to claim 1, further including a hook formed with a barb near an end and ridges near an opposite end and pivotally connected to the handle, wherein the sheath includes a block formed thereon for engagement with the barb.

3. The cutting apparatus according to claim 1, wherein the blade carrier includes at least one rod formed thereon, wherein the jaw includes at least one aperture for receiving the rod.

4. The cutting apparatus according to claim 1, further including a spring compressed between the blade carrier and the jaw.

5. The cutting apparatus according to claim 1, further including a spring compressed between the sheath and the second button.

6. The cutting apparatus according to claim 1, further including a leaf spring located in the cassette for pushing the blade toward an internal face of the cassette near the exit.

7. The cutting apparatus according to claim 1, wherein the cassette includes an elastic strip formed thereon, wherein the positioning block is formed on the elastic strip, wherein the positioning block is moved out of the positioning aperture when the elastic strip is bent.
